(19) United States
(12) Patent Application Publication
(10) Pub. No.: US 2015/0290982 A1
(43) Pub. Date: Oct. 15, 2015

(54) Designer tires

(71) Applicant: Carlayne Sims, New York, NY (US)

(72) Inventor: Carlayne Sims, New York, NY (US)

(21) Appl. No.: 14/545,214

(22) Filed: Apr. 7, 2015

Related U.S. Application Data
(60) Provisional application No. 61/978,852, filed on Apr. 12, 2014.

(51) Int. Cl. B60C 13/00; B60B 21/12; B60K 16/00; B60C 99/00

(52) U.S. Cl. CPC B60C 13/001; B60C 99/00; B60B 21/12; B60K 16/00; B60K 2016/003

(57) ABSTRACT

The specific nature of my invention is to manufacture Designer Tires. Which are tires in assorted colors completely rubber dyed with its rims and wheels in Designer Tires Colors also.

Solar Pane Rims is rims that will be rechargeable by sunlight and will distribute D.C. current to electric cars. SOLAR PANEL RIMS will also be manufactured in DESIGNER TIRES COLORS.

DIGITAL CARS is needed cause they will use less electricity for B.M.T maximum BRAKE TORQUE. DESIGNER TIRES COLORS will bring tires, wheels and rims into a world full of color.

Remote Control Interchangeable Rims and the Designer Tires wheels for them is all so 21 century completed automotive year.

### CROSS REFERENCE TO RELATED APPLICATION

Provisional Patent & Application No. 61/978852

The Purpose of the provisional was to allow Invent Company to develop and market my DESIGNER TIRES to manufactures, while I seek investors.

### BACKGROUND OF INVENTION

Black tires was the standard tire since the invention of the car Designer Tires will add dimension to buying styles of tires in the 21 century. Secondly by introducing color to the tire market will not only be great for American economics, it will also maintain the liberty to further personalize one's own car or automotive vehicles, an bikes. In the 21 century. Designer Tires will at customers request have printed logo's and trade marks.

Designer Tires Provisional No. 61/978852 has the abstract and earlier drawings. Per my phone call to U.S. P.T.O. CONTACT CENTER ON Mar. 23, 2015 ref# 1-324-745765. I will with this non-provisional application add additional and improved traced prior art of someone else, I am also submitting with this non-provisional a petition for color drawings. That will profoundly display the detail of my new invention.

The Wheels and Rims will also be in DESIGNER TIRES colors. Wheels nor Rims was colored before my concept for DESIGNER TIRES. My Solar Panel Rims for electric car and my new invention digital vehicle concept was conceived by me when I was preparing to transcribe this non-provisional on Jan. 25, 2015. Solar Panels Rims will also be in DESIGNER TIRES COLORS. Both my invention of Solar Panel Rims and Digital Vehicles came into concept on Jan. 25, 2015. As I prepare this non-provisional to complete Designer Tires for the 21 century; Digital car will use less electricity than todays electric car.

The background for Interchangeable Rims was my invention while preparing Designer Tires on May Seventh 2013. When I started preparing my Non-Provisional, I took my Interchangeable Rims further on March Twenty Fifth 2015 and turned them into Remote Control Interchangeable Rims for my Designer Tires.

### BRIEF SUMMARY OF THE INVENTION

I Carlayne Sims have invented a new concept for Tires, Wheels, and Rims.

My Invention is name DESIGNER TIRES. Which is the complete coloring of rubber tires and wheels, to include the coloring of rims, and my newly added invention to my utility claim my SOLAR PANEL RIMS on my non-provisional application. My SOLAR PANELS RIMS will be in assorted colors also. Designer Tires=Tires, Wheels and Rims will be designed for every type of automotive vehicle, and every type bike from tricycles to bicycles, and motor bikes, that includes motorcycles.

1. The specification is to use rubber from rubber trees, and also all material that meets U.S. gov. and international standards for making tires and wheels for rubber wheels. This includes all rubber compounds will be used to make color rubber tires and wheels. The colored rubber tires and the multitude of threads needed to make Designer Tires that fit the U.S. gov. and international standards for automotive tires, motorcycle tires, bike tires will be manufactured in assorted colors. Or I will have to manufacture them myself. My Designer Tires will also have customized logos by order of customers. Designer Tires will be made of the newest material and threads for Radial tires and steel belted tires and tyres. Designer Tires will be made for all types of tires all weather and all roads.

2. The specific target for my Designer Tires are:

(1) Cars, (2) Trucks, (3) Rubber wheel vehicles that go outer space, (4) Eighteen Wheelers, (5) R.V.'s, (6) S.U.V.'s, (7) Toys, (8) Air Plane tires, (9) Motorcycles, (10) Wheels for Carts, Hand Trucks, Carriages, Skate Boards, Roller Blades, Pulleys, Toy cars, trucks.

3. The Medal Wheels of Designer Tires will be in assorted colors matching the Designer Tires while not necessarily used together. They can be manufactured separately, sold separately, and used separately; As well as manufactured together, sold together, and used together. The specific target for my Designer Tires Wheels are the same as the tires as follows: (1) Cars, (2) Trucks, (3) R.V.'s, (4) S.U.V.'s (5) Motor Cycle, (6) Bicycle and etc., (7) Eighteen Wheelers and etc.

4. The Medal Rims of Designer Tires will also be Made in assorted colors matching the Designer Tires; To be manufactured, sold, and used in the same manner as item three of this section of the Brief Summary of the Invention.

5. The advantage of the invention is to give drivers a greater selective choice about their automotive vehicles styles, and from motorcycle riders to bike they can all add to their own personal flairs. Plus it is the 21 century and the tires, wheels, and rims are and have basically remained the same, since it's making. Finally if hopefully not there was an accident one would know what color tires were involved including law enforcement.

6. Designer Tires will also manufacture and feature newly added to my inventory coloring, Solar Panel Rims. That will be function as rechargeable batteries for electric and my future Digital Car. Solar Panel Rims will recharge itself by sun light photosynthesis. Solar Panel Rims will also be in Designer Tires Colors.

7. Designer Tires will also manufacture+future newly added to my inventory Coloring Remote Control Interchangeable Rims. These are Rims that will lock to Designer Tires Wheels will open and lock by Remote Control. These Rims will also be in Designer Tires Colors. Remote Control Rims will also resolve the problem of stolen Rims.

Completing the full range of Designer Tires for the 21 Century.

### DETAILED DESCRIPTION OF THE INVENTION

1. 1A—DESIGNER TIRES are tires that will be made out of assorted rubber dyed colors. That will be made from rubber from rubber trees to rubber compounds that are U.S. Government and International standard's approved. For the use of tires. The treads for my invention of colored tires will also meet U.S. and International Government standards. Designer Tries will open the market for a wider selection of tires plus the manufacturing in the 21 century. They will add additional detailing and recognition to automotive vehicle and bikes. Hopefully not needed but if an accident occurs the colored tires will also add further trace evidence.

2. 1B—The Wheels and Rims following my concept for colored tired are usually manufactured together with their tires. So to complete the process I too will have wheels and rims to accompany my designer tires. They will be in DESIGNER TIRES COLORS also. They will be made out of metals and of governmental standard both U.S. and International.

3. 1C—SOLAR PANEL RIMS my new inventions added to this non-provision. Jan. 25, 2015 is also going to be in assorted colors.

4. DESIGNER TIRES and its accompanying parts will be manufactured in assorted colors and meet all standard size tires and tyres for todays; CARS, TRUCKS, AND ETC., ALL MOTORCYCLES AND BIKES.

5. DESIGNER TIRES colors will also be used for other assortment of tires and wheels for toys, hand truck, carts carriages, and etc. The concept is to bring wheel, tires, rims, and tyres into the 21 CENTRUY. In COLOR.

6. DESIGNER TIRES RIMS will also feature Rims that are interchangeable. These rims will have remote control lock by personal remote control. And of course these rims will also be manufacture in DESIGNER TIRES COLORS. The dyes for DESIGNER TIRES COLORS will meet U.S. and International Governmental standard for dyes that dye rubber manufacture for tires, metal, and plastic for DESIGNER TIRES wheels and rims.

7. DESIGNER TIRES will also manufacture inner tubes for assorted bikes in Designer Tires Colors.

### BRIEF DESCRIPTION OF THE SEVERAL VIEWS OF THE DRAWING

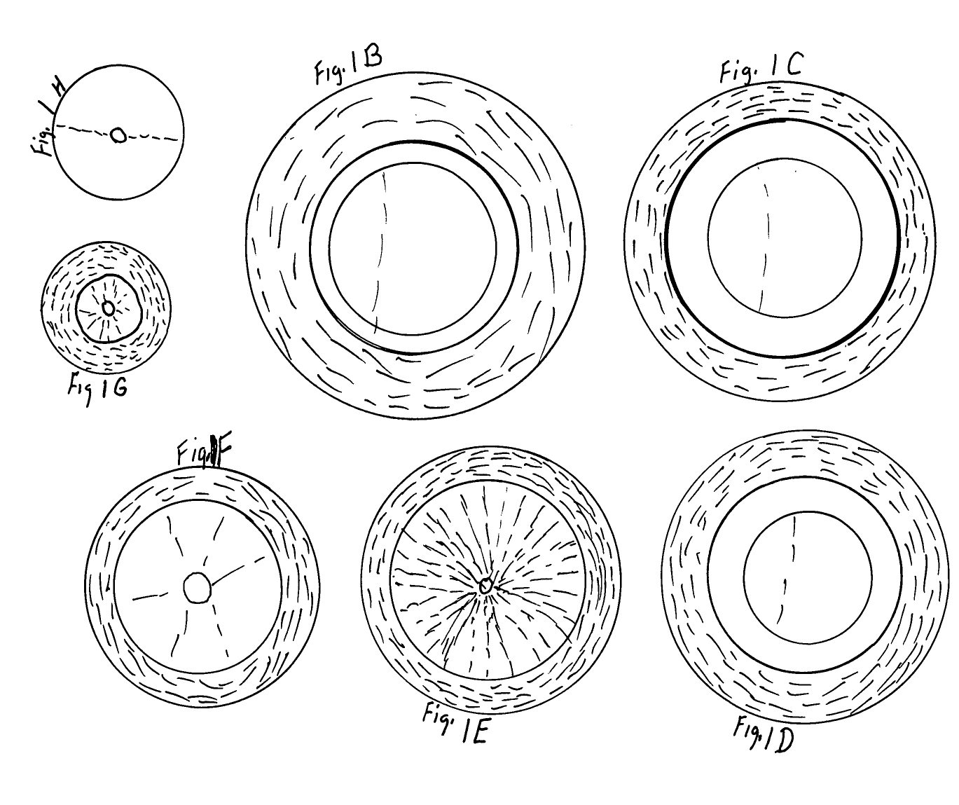

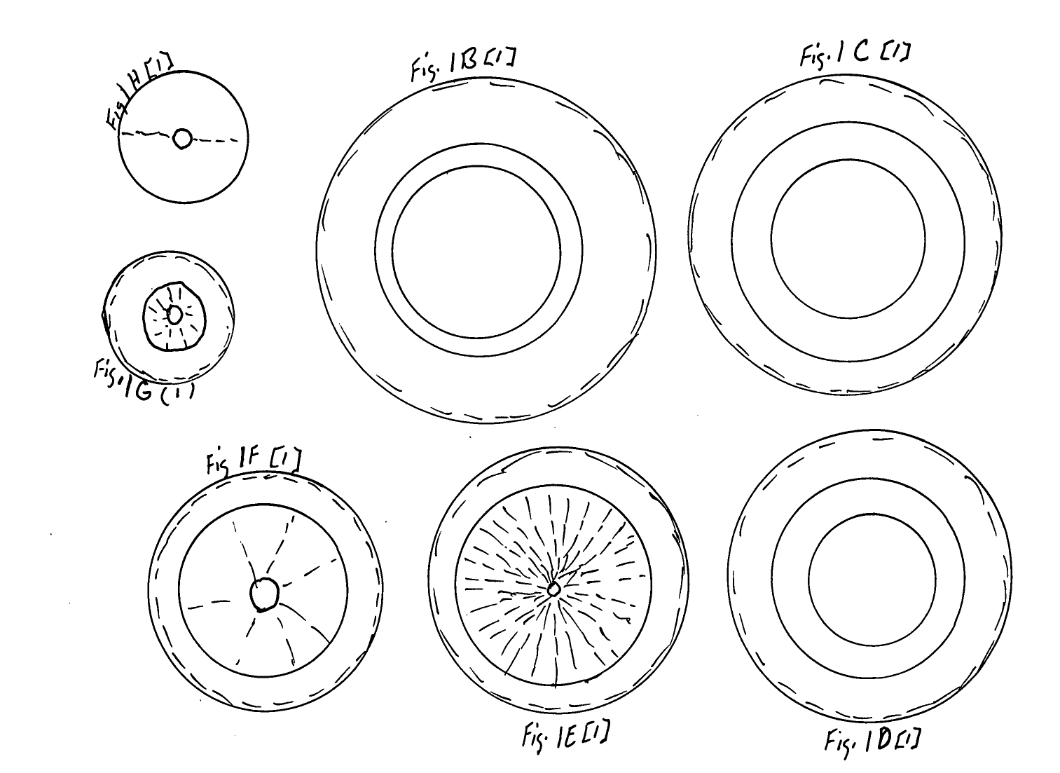

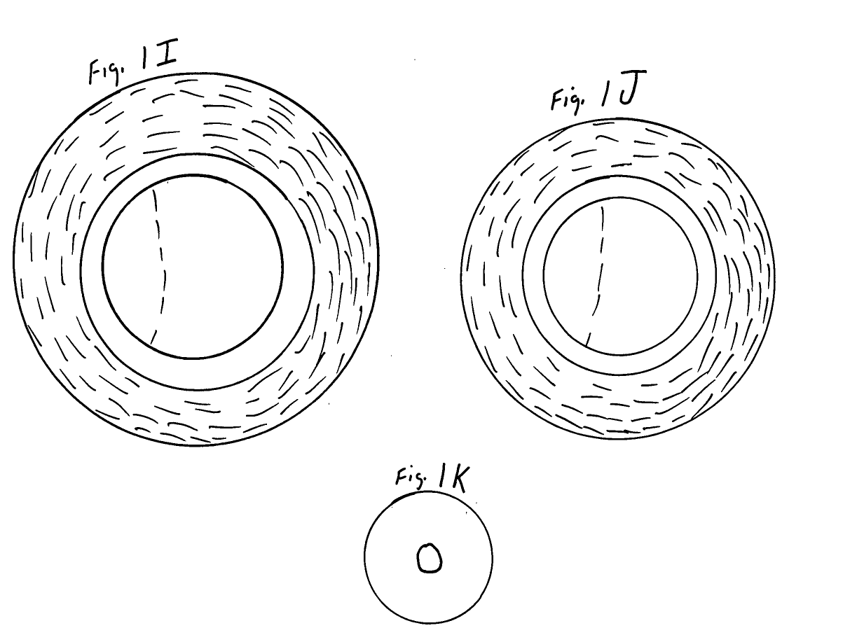

1. FIG. 1A (1) is a small copy of the illustrated copy drawing of the U.S. P.T.O. tire in the Design Guide booklet. And it's what I will significantly use to display m invention to your office upon being granted permission to submit my color copes. Which is the basis of my invention the color aspect. FIG. 1A (2) is my trace drawing of 1A (1); FIG. 1A (3) is my copy of my trace drawing of FIG. 1A (1).

2. FIG. 1B is a copy and drawing that depict the front side view of my designer tires in black and white. With an e.g., Logo inscripted “Twenty First Century.” This tire image is a depiction for large rubber color tires for trucks and S.U.V.s.

3. FIG. 1C is a cop and drawing that depict the front side view of a rubber tire with e.g., Logo “Tyre or Tire” for cars, the broken lines are for assorted treads.

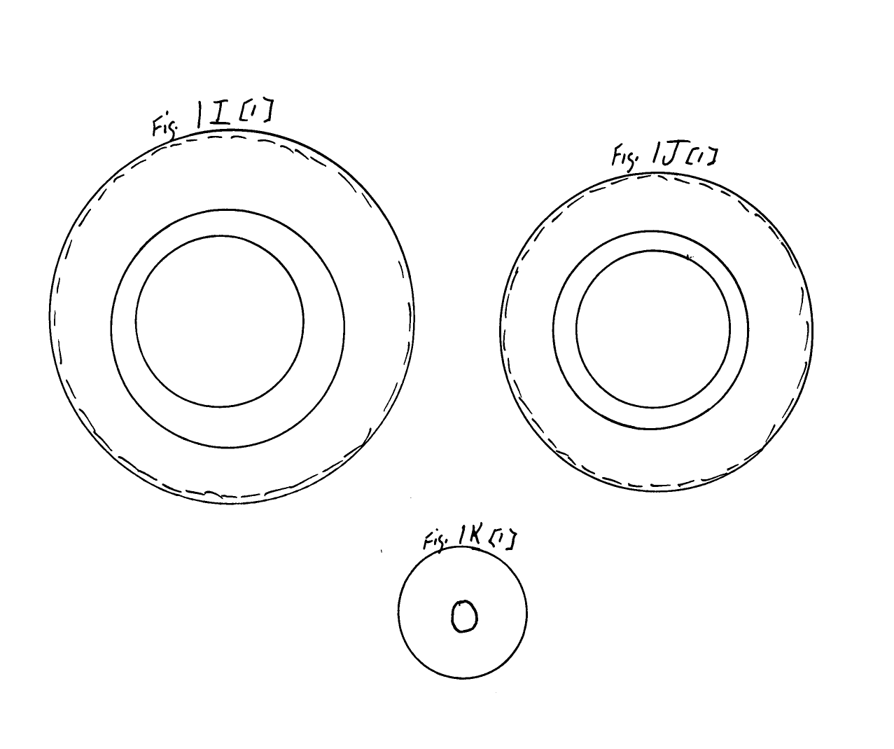

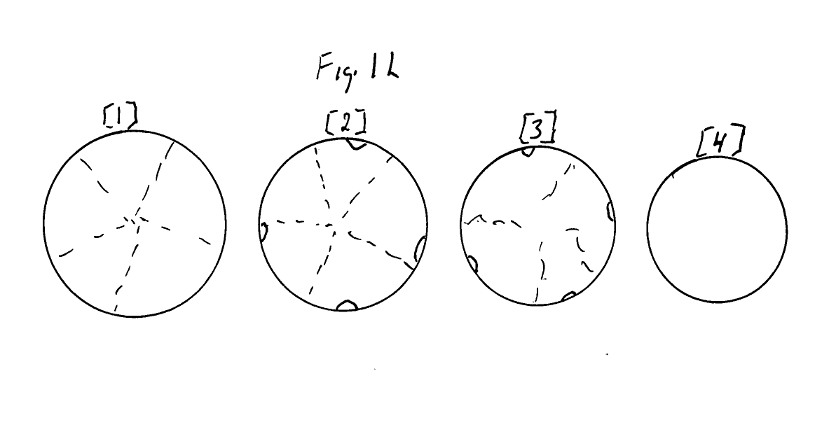

4. FIG. 10 is a copy drawing for the depiction for a rubber motorcycles tire also with a e.g., Logo “Cycled By” front side view and the broken lines are depiction of assorted treads.

5. FIG. 1E is a copy and drawing for the depiction for a rubber tire for a bicycle, with a bicycle rim within the tire that will be made out of medal like chrome, and will be colored like the DESIGNER TIRES rubber colored tires.

6. FIG. 1F is depiction of tires and wheel for carts, such as shopping carts and etc. . . Made out of rubber the tires and wheel will be in Designer Tires colors, the wheels will be made out of a plastic.

7. FIG. 1G is depiction of tire and wheel for toys, such as cars, and truck; made out of rubber the tires and wheels will be in Designer Tire Colors, the wheels will be made out of a plastic.

8. FIG. 1H is a depiction of wheel for Skateboards, and Roller Blades that will be manufactured in DESIGNER TIRES COLORS. These wheels will be made and manufactured out of rubber and rubber compounds. All of the Figures on page two of my drawings are of the front side angle of tires, wheels, and rims. The tires and wheels are made for rubber and the rims are designed for plastic and metal.

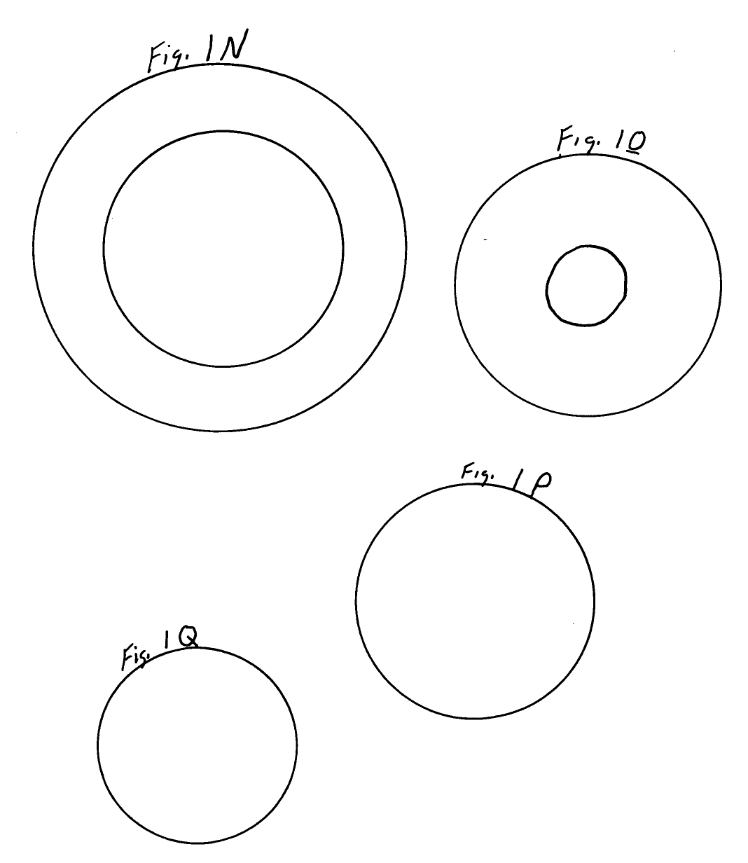

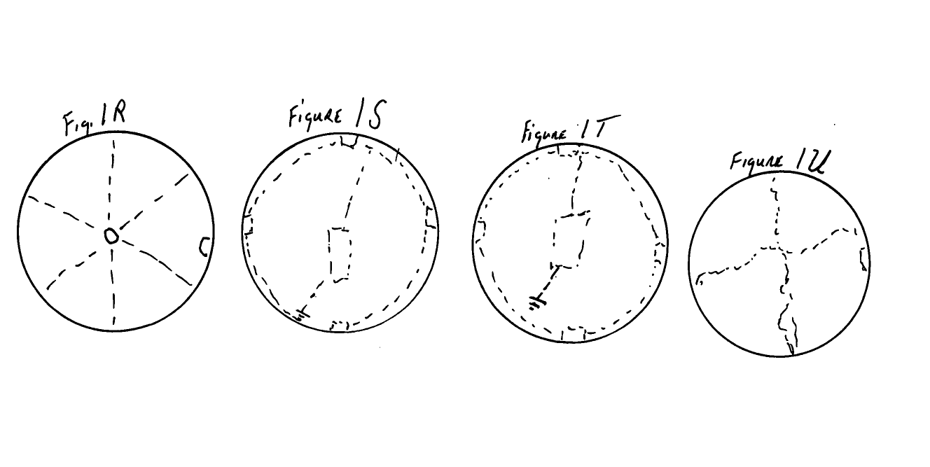

9. FIG. 11 is a depiction of tire to be manufactured for Tractor Trailers in DESIGNER TIRES COLORS. This too is a front side angle view.

10. FIG. 1J is a depiction of a tire to be manufactured for R.V.s. in DESIGNER TIRES COLORS. This too is a front side angle view.

11. FIG. 1K is a depiction of wheel and tire for hand trucks this too is the front side view. And will be manufactured in DESIGNER TIRES COLORS. Page three may have LOGO's on the front side of tires also and the back will be in the same color with no logo's. The rims of FIG. 1K will be manufactured in plastic and in rubber DESIGNER TIRES COLORS.

12. FIG. 1L is a depiction of DESIGNER TIRE INTERCHANGABLE RIMS the four pros or latch clamps that will remotely lock in place as indicated in the two center pictures in there rare view, the two outer rims are the front view and the one on the right is a plain rim and the on the left is the front view that has a broken link design. All the rims on page for will be in DWSIGNER TIRES COLORS. And will be manufactured out of metal and or plastic.

13. FIG. 1N is the front view of Designer Tires Solar Panel Rims.

14. FIG. 10 is the Wheel Designer Tires Solar panel Rims will be connected to.

15. FIG. 1P is the transparent cover of the Rim for the Solar Panel Rims.

16. FIG. 1Q is the Electroplate of nickel cadmium that is rechargeable by the sun that will be under the transparent cover of the Rims.

17. FIG. 1R is the front cover with a remote sensor on it for Designer Tires Interchangeable Remote Control Rims that will lock by Remote Control.

18. FIG. 1S is the inner circuitry for Designer Tires Remote Control Interchangeable Rims. The remote control switch that is in a series circuit connected to spring locks four spring locks that will lock on to the Designer Tires wheels that will be designed for designer tires Remote Control Interchangeable Rims.

19. FIG. 1T is the same inner circuitry of FIG. 1S of Designer Tires remote locking rims, interchangeable locking rims.

20. FIG. 1U is the same as FIG. 1R front cover with a senor built into it only difference is the broken line design.

21. FIG. 1V is a copy of Invent Company Brochure that was to market DESIGNER TIRES. If I am granted submission of my colored submission I will submit my drawings in color, which is the basis of my invention.

1. FIG. 1a is an illustration of Prior Art that I traced from U.S.P.T.O. manual titled guide to Filling a Design Patent Application. My color drawings upon acceptance will display this illustration traced tire in full color, which will illustrate my invention for my DESIGNER TIRES.

2. Page two FIG. 1B; 1C; 1O; 1E; 1F; 1G; & 1H is all of my drawings of Tires, Tyres, Wheels, and Rims that will be manufactured in Designer Tires Color.

3. Wheels FIG. 1M is also Prior Art that I traced from U.S.P.T.O. manual titled Guide to Filling a Design Patent Application. My DESIGNER TIRES Wheels will be manufactured in Designer Tires Colors also. Most tires and wheels are manufactures together.

4. Rims in FIG. 1L I'm not to much at drawing but these are metal rims for automotive vehicles that will be manufactured for vehicles in all there different sizes, but they will all be manufactured in DESIGNER TIRES COLORS.

5. SOLAR PANEL RIMS will be electroplated solar panel rims for electric vehicles that also brought me into the need to invent DIGITAL VEHICLES. FIGS. 1N; 1O; 1P; and 1Q. MY SOLOR PANEL RIMS will be manufactured in my DESIGNER TIRES COLORS also.

6. DIGITAL CARS is needed for my SOLAR PANEL RIMS of my DESIGNER TIRES! Virtually competing a New look Style & Function for the 21 Century Automotive.

7. Designer Tires will also manufacture Remote Control Rims. FIG. 1R is the front of Remote Control Rim, with a Sensor attached. These Interchangeable Remote Controlled Locked Rims will also be manufactured in DESIGNER TIRES assorted COLORS.
